(19) United States
(12) Patent Application Publication
(10) Pub. No.: US 2007/0185955 A1
(43) Pub. Date: Aug. 9, 2007

(54) REMOTE CONSOLE APPARATUS, REMOTE OPERATION METHOD AND REMOTE CONSOLE PROGRAM

(75) Inventor: Yoshio KOIKE, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/428,592

(22) Filed: Jul. 5, 2006

(30) Foreign Application Priority Data
Feb. 8, 2006 (JP) 2006-030705

(51) Int. Cl. G06F 15/16

(52) U.S. Cl. 709/203

(57) ABSTRACT

The present invention provides a remote console apparatus including a storage unit for storing a remote console program which performs a remote operation of an electronic apparatus; a file for substituting for an operation interface of the remote console program; and a storage unit for storing an operation program which is connected to the remote console program by way of the file, and automates the remote operation of the electronic apparatus by the remote console program through read and write operations of information from and to the file.

### BACKGROUND OF THE INVENTION

1. Field of the Invention

The present invention relates to a remote operation technique, for example to a technique effectively applicable to a remote operation, monitor, operation test, et cetera, of a various electronic apparatus such as information processing apparatus and network apparatus.

2. Description of the Related Art

In association with the development of information societies, a distributedly placed large number of information processing apparatuses are commonly operated in the aspect of being complexly connected by way of an information network. This makes a remote operation and a remote monitor of a various electronic apparatuses such as individual information processing apparatuses and network apparatuses represented by a relay equipment used for an information network inevitable for accomplishing an effective operation of a system.

Conventionally known technique for remotely operating an electronic apparatus by way of an information network is for example is one used as a remote console by installing a remote console program comprising a client function of the telnet protocol in a personal computer (PC) or the like which comprises a display, a key board, et cetera.

That is, what is adopted is a method for an operator inputting a command from a key board, visually confirming a command execution result or visually judging an error message, etcetera, byway of an information display to an operator screen (display) and a key board input which are provided by the remote console program as an operation-use interface, thereby carrying out a remote operation of an electronic apparatus such as server apparatus and network equipment as the subject of management.

Remote operations of electronic apparatuses, however, often involve a repetition of fixed pattern input and output operations for an operator interface such as display and key board, and therefore such manual inputs required of the operator levies a large load on him/her.

Because of this, a patent document 1 for example has disclosed a technique for attempting to automate key input operations by equipping a console input keyboard apparatus with a mechanism for detachably attaching a memory card storing an operation definition file which defines key input operations. This configuration, however, is faced with a technical problem of requiring a special key board accommodating the memory card and hence is lacking versatility.

Meanwhile, a patent document 2 has disclosed a technique for attempting to implement generation of a command list, by a simple panel input, for a system message automation interface used for an integrated network management program which uses SNMP (Simple Network Management Protocol).

The case of the patent document 2 is also the same in terms of requiring a cumbersome work that is a panel input. Furthermore, the aforementioned panel is also faced with a technical problem of lacking versatility of a general purpose input unit such as keyboard since the panel is equipped especially for a generation of the command list.

[Patent document 1] Laid-Open Japanese Patent Application Publication No. 2001-356932

[Patent document 2] Laid-Open Japanese Patent Application Publication No. 05-113955

### SUMMARY OF THE INVENTION

A purpose of the present invention is to provide a technique for making it possible to implement an automation of remote console key input operations without hampering versatility.

Another purpose of the present invention is to provide a technique for making it possible to implement an automation of operations, e.g., a remote operation, a remote maintenance, a remote monitor, an abnormality judgment and an automatic recovery, of an electronic apparatus requiring complex and diverse key input operations of a remote console without hampering versatility.

A first aspect of the present invention is to provide a remote console apparatus including a storage unit for storing a remote console program which performs a remote operation of an electronic apparatus; a file for substituting for an operation interface of the remote console program; and a storage unit for storing an operation program which is connected to the remote console program by way of the file, and automates the remote operation of the electronic apparatus by the remote console program through read and write operations of information from and to the file.

A second aspect of the present invention is to provide a remote operation method, including: a first step for connecting, by way of a file which substitutes for an operation interface, a remote console program and an operation program which provide the operation interface for the purpose of performing a remote operation of an electronic apparatus; and a second step for automatically per forming the remote operation of the electronic apparatus by way of the remote console program by the operation program performing read and write operations of information from and to the file.

A third aspect of the present invention is to provide a remote console program, making a computer accomplish the functions of substituting a file for an operation interface for the purpose of performing a remote operation of an electronic apparatus, and automatically carrying out the remote operation of the electronic apparatus by using information exchanged with another operation program by way of the file.

A conventional input and output operation of a remote console which is connected to an electronic apparatus such as a server required manual works by an operator as described above.

Contrarily, the present invention is for example configured to enable transmission of a command to an electronic apparatus as the subject of control, confirmation of a command execution result at the electronic apparatus and monitoring of an asynchronous event message, et cetera, all automatically, by an operation program controlling the operation of a remote console program by way of a file, thereby implementing an automation of the operator work.

And, it requires none of dedicated input equipments such as a specially configured key board or touch panel for automating key inputs, hence it keeps versatility.

That is, the present invention enables the operation program to operate by way of the file substituting input and output operations for an operation interface of a remote console program without needing special hardware. Accordingly, a preparation of an operation program makes it possible to completely automate all console operations for a remote operation of an electronic apparatus without hampering versatility.

The present invention also enables automation in generation of a quasi-failure, collection of log data, recovery processing for an electronic apparatus, et cetera, at the time of testing the electronic apparatus by collaborating with a quasi-failure generation function installed in the electronic apparatuses such as a server apparatus as the subject of control and with a quasi-failure signal externally applied to the electronic apparatus.

And a connection to a console interface of an electronic apparatus such as network equipment enables an automatic operation testing by changing various settings of the network equipment, et cetera.

Or, it is possible to judge, by preparing an operation program for monitoring by way of a file, an abnormal state at the time of such state of an electronic apparatus based on a console message output from the electronic apparatus such as a server apparatus in operation, thereby automating recovery processing, et cetera.

### BRIEF DESCRIPTION OF THE DRAWINGS

FIG. 1 is a conceptual diagram exemplifying an operation of a remote console apparatus and a remote console program embodying a remote operation method according to an embodiment of the present invention;

FIG. 2 is a block diagram exemplifying a configuration of a remote console apparatus according to an embodiment of the present invention;

FIG. 3 is a conceptual diagram exemplifying a connection form between a remote console apparatus according to an embodiment of the present invention and an electronic apparatus as the subject of control;

FIG. 4 is a conceptual diagram showing a modified example of connection form between a remote console apparatus according to an embodiment of the present invention and an electronic apparatus as the subject of control;

FIG. 5 is a conceptual diagram exemplifying a method for accessing various kinds of files existing between a remote console program and an operation program in a remote console apparatus according to an embodiment of the present invention;

FIG. 6 is a flowchart exemplifying an operation of a remote console program for a remote console apparatus according to an embodiment of the present invention;

FIG. 7 is a flow chart exemplifying an operation of an operation program for a remote console apparatus according to an embodiment of the present invention;

FIG. 8 is a description diagram exemplifying record contents of an output file for a remote console apparatus according to an embodiment of the present invention;

FIG. 9 is a sequence chart exemplifying an operation program and an operation thereof for a remote console apparatus according to an embodiment of the present invention; and

FIG. 10 is a sequence chart exemplifying an operation program and an operation thereof for a remote console apparatus according to an embodiment of the present invention.

### DESCRIPTION OF THE PREFERRED EMBODIMENTS

The following is a detailed description of the preferred embodiment of the present invention by referring to the accompanying drawings.

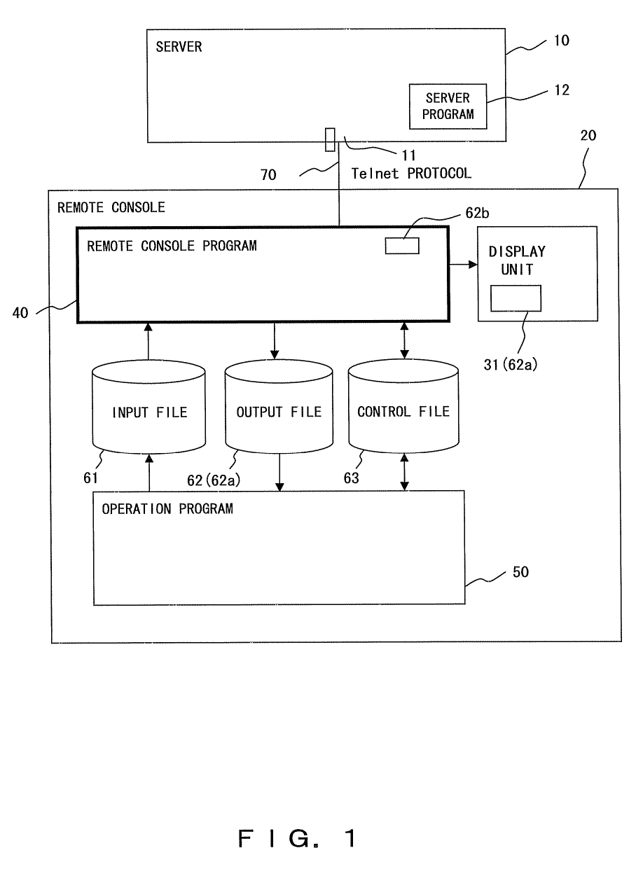

FIG. 1 is a conceptual diagram exemplifying an operation of a remote console apparatus and a remote console program embodying a remote operation method according to an embodiment of the present invention.

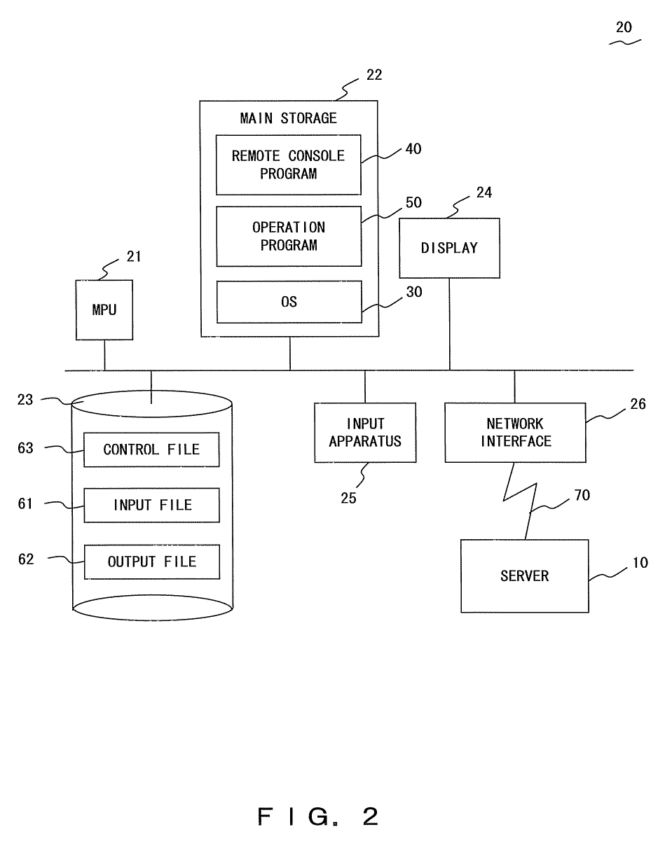

FIG. 2 is a block diagram exemplifying a configuration of a remote console apparatus according to the present embodiment.

First of all, an example configuration of the remote console apparatus according to the present embodiment is described by referring to FIG. 2.

The remote console apparatus 20 according to the present embodiment includes a central processing unit 21, a main storage 22 (i.e., a storage unit), an external storage apparatus 23, a display unit 24, a user input apparatus 25 and a network interface 26.

The central processing unit 21 comprises micro processor unit (MPU) for example.

The central processing unit 21 executes an operating system (OS) 30 stored by the main storage 22, thereby controlling the entirety of the remote console apparatus 20.

The main storage 22 comprises semiconductor memory for example. The main storage 22 stores the operating system 30 which is the basic software, a remote console program 40 which operates under the control of the operating system 30 and an operation program 60.

The present embodiment is configured to implement a remote operation of an electronic apparatus 10 as described later by the central processing unit 21 executing a remote console program 40 and an operation program 50 which operate under the control of the operating system 30.

The external storage apparatus 23 comprises a storage apparatus having a nonvolatile storage medium. The present embodiment is configured such that the external storage apparatus 23 stores an input file 61, an output file 62 and a control file 63 which are used for exchanging information between the remote console program 40 and operation program 50.

Although not particularly shown herein, the operating system 30, remote console program 40 and operation program 50 are stored by the external storage apparatus 23. And these are read to the main storage 22 and executed by the central processing unit 21.

The display unit 24 visualizes, on an as required basis, information generated at an execution of software such as the operating system 30, remote console program 40, operation program 50, etcetera, and a message coming from the electronic apparatus 10, and presents them to the user operating the remote console apparatus 20.

The user input apparatus 25, comprising an information input apparatus such as key board, mouse, et cetera, is used for information inputs by the user operating the remote console apparatus 20.

The network interface 26 provides a communication interface using a telecommunication medium 70 such as a LAN interface. The telecommunication medium 70 may be a cabled telecommunication medium or a wireless telecommunication medium.

The present embodiment is configured to perform a remote operation of the electronic apparatus 10 by connecting the remote console apparatus 20 thereto by way of the telecommunication medium 70.

As exemplified in FIG. 1, the present embodiment is configured to install a remote console program 40 and operation program 50 for operating the remote console program 40 in the remote console apparatus 20 which is connected, by way of a telecommunication medium 70, to the electronic apparatus 10 as the subject of control such as server and network equipment.

And the operation program 50 controlling the remote console program 40 byway of the input file 61, output file 62 and control file 63 automates console operations for the electronic apparatus 10 from the remote console program 40.

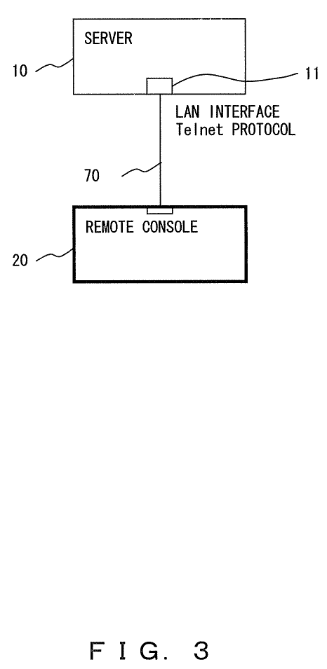

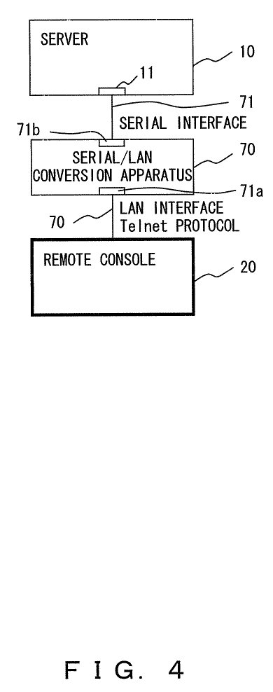

FIGS. 3 and 4 are conceptual diagrams exemplifying connection forms between a remote console apparatus 20 (i.e., remote console program 40) according to the present embodiment and an electronic apparatus 10 as the subject of control.

FIG. 3 shows the case of connecting between a console interface 11 of the electronic apparatus 10 and remote console apparatus 20 directly by the telecommunication medium 70 such as a LAN interface (i.e., telnet protocol), et cetera. This connection form is exemplified by FIG. 1.

FIG. 4 shows the case of a console interface 11 of the electronic apparatus 10 being a serial interface, which has the intervention of a telecommunication media conversion apparatus 71 for performing a serial interface/LAN interface conversion, thereby connecting with the remote console program 40 according to the present embodiment.

That is, the telecommunication media conversion apparatus 71, comprising a LAN interface 71a and a serial interface 71b, is connected to the remote console apparatus 20 by way of the LAN interface 71a and telecommunication medium 70, and is connected to the electronic apparatus 10 by way of the serial interface 71b and a serial telecommunication medium 72.

As exemplified by FIG. 1, the remote console program 40 and electronic apparatus 10 as the connection destination are interconnected by the form of the above described FIG. 3 or FIG. 4 in the remote console apparatus 20 according to the present embodiment.

In the case of a server program 12 at the electronic apparatus 10 being a telnet server, et cetera, for example, the remote console program 40 functions as telnet client.

Note that a connection interface between the electronic apparatus 10 and remote console apparatus 20 is not limited to the telnet protocol. For instance, if the electronic apparatus 10 as the subject of control is a network equipment, a protocol such as SNMP (Simple Network Management Protocol) can also be used.

The operation program 50 is connected to the remote console program 40 by way of the input file 61, output file 62 and control file 63.

The remote console program 40 displays, in a terminal window 31 of the display unit 24, data such as a reception message 62a, et cetera, received from the electronic apparatus 10 during a console operation.

Or, an output destination of the reception message 62a can be changed over to an output file 62 from the terminal window 31.

The remote console program 40 is capable of changing an input source of a console operation input, which is input from the user input apparatus 25 for the purpose of controlling the electronic apparatus 10, over to the input file 61 or control file 63.

The remote console program 40 is also capable of outputting an operation state of the program itself to the control file 63.

As described above, the present embodiment is configured for the operation program 50 reading and writing from and to the input file 61, output file 62 and control file 63, thereby controlling console operations of the remote console program 40 from the operation program 50.

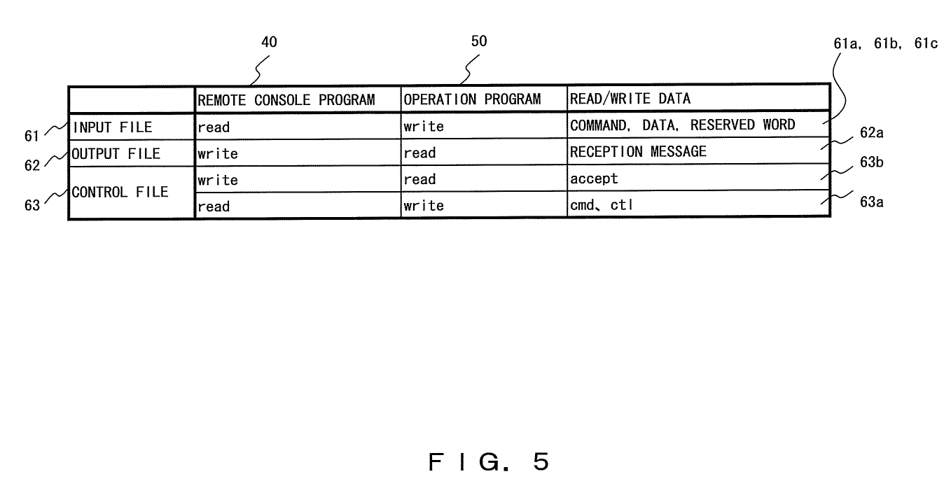

The next description is of an example method for the remote console program 40 and operation program 50 accessing the input file 61, output file 62 and control file 63 according to the present embodiment by referring to FIG. 5.

The input file 61 is simultaneously opened, and shared, by the remote console program 40 and operation program 50.

The remote console program 40 is allowed only to read (i.e., “read”) from the input file 61.

The operation program 50 is allowed only to write (i.e., “write”) to the input file 61.

The present embodiment is configured for the operation program 50 to write information such as a command 61a (i.e., a first character string), data 61b (i.e., a first character string), and a reserved word 61c (i.e., a first character string), et cetera.

The command 61a is an instruction which is transmitted to an electronic apparatus 10 as the subject of control in order to make the aforementioned electronic apparatus 10 perform a specific operation.

The data 61b is data such as a character string, et cetera, transmitted to an electronic apparatus 10 as the subject of control.

In the present embodiment, the remote console program 40 comprises the function which attaches a line feed code (which is equivalent to pressing a carriage return (CR) key of a key board) at the tail end for the command 61a and data 61b, and sends them to the electronic apparatus 10.

The reserved word 61c is information interpreted by a remote console program 40, thereby making the aforementioned remote console program 40 perform a specific operation.

The present embodiment is configured to furnish the reserved words 61c with words, e.g., “CTL-A”, “CTL-B” through “CTL-Z”, “BREAK”, “ESC”, etcetera, for making the remote console program 40 transmit respective specific control codes to the electronic apparatus 10.

For instance, the reserved word 61c of “CTL-A” makes a control code, which is input to the remote console program 40 in the case of pressing the CTL key and “A” key at the user input apparatus 25 such as a key board, generated in the inside of the remote console program 40.

Likewise, the “BREAK” and “ESC” make respective control codes, which are input to the remote console program 40 in the case of respectively pressing the BREAK key and ESC key, generated in the inside of the remote console program 40.

And the reserved words 61c include “ON” and “OFF” in order to operate an output flag 62b for controlling a start/stop of writing a console message to the output file 62 from the remote console program 40.

The reserved words 61c also include “END” for the purpose of making the remote console program 40 end an operation.

The output file 62 is simultaneously opened, and shared, by the remote console program 40 and operation program 50.

The remote console program 40 is capable of an operation of only writing (i.e., “write”) information, such as a reception message 62a received from the electronic apparatus 10, to the output file 62. The appropriateness of a write operation for the reception message 62a is determined by an output flag 62b which is controlled by the above described reserved words 61c of “ON” and “OFF”.

Note that a configuration may be such that the remote console program 40 displays a reception message 62a constantly in the terminal window 31 even in the case of the output flag 62b being “ON” for outputting the reception message 62a to the output file 62. Such a configuration provides a benefit of enabling the user to constantly monitor visually the operation states of the electronic apparatus 10 and remote console program 40.

The operation program 50 is allowed only a read operation (i.e., “read”) from the output file 62.

The control file 63 is simultaneously opened, and shared, by the remote console program 40 and operation program 50.

The remote console program 40 and operation program 50 are both allowed a write operation (i.e., “write”) and a read operation (i.e., “read”) to and from the control file 63.

The remote console program 40 writes, to the control file 63, a state indication character string 63b (i.e., “accept”) (i.e., a second character string) which indicates the state of being able to receive an instruction from the operation program 50.

The operation program 50 reads the state indication character string 63b from the control file 63, thereby being able to know the state of the remote console program 40.

The operation program 50 writes a process request character string 63a (i.e., a second character string) to the control file 63, while the remote console program 40 reads the process request character string 63a.

The present embodiment is configured to furnish the process request character string 63a with “cmd” and “ctl”.

The “cmd” is a character string for instructing the remote console program 40 to attach a line feed code to a character string written to the input file 61 from the operation program 50 as a command 61a or data 61b, followed by transmitting it to the electronic apparatus 10.

The “ctl” is a character string for instructing the remote console program 40 to interpret a character string written to the input file 61 from the operation program 50 as a reserved word 61c and execute an applicable operation.

The following description is of an operation of the present embodiment.

The terminal window 31 is opened by the operating system 30 in the display unit 24 of the remote console apparatus 20.

An input of a start command for the remote console program 40 and operation program 50 into the terminal window 31 starts up the remote console program 40 and operation program 50, making the apparatus a state of execution as shown by FIG. 1.

A message output from the remote console program 40 in execution and a reception message 62a coming from the electronic apparatus 10 as the connection destination are displayed in the terminal window 31 and stored in the output file 62 on an as required basis, as described later.

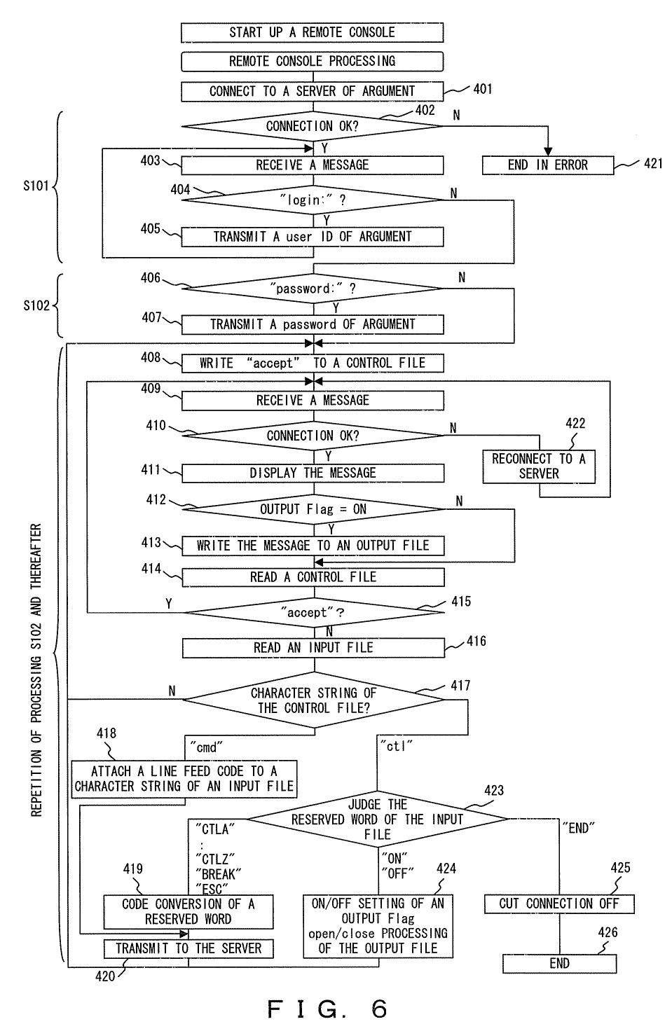

FIG. 6 is a flow chart exemplifying an operation of the remote console program 40.

An input of a program name of the remote console program 40 and arguments (e.g., an electronic apparatus of the connection destination, a user ID, the password, etcetera) from the terminal window 31 starts up the remote console program 40, followed by trying to connect to an electronic apparatus 10 such as a server specified by the argument (step 401).

If a connection fails, the remote console program 40 ends as error (step 421).

If the connection succeeds (step 402), the remote console program 40 receives a reception message 62a from the electronic apparatus 10 (step 403) and transmits a user ID thereto (step 405) in response to the reception message 62a of “login:” (step 404).

These steps 402 through 405 constitute a process block S101.

Subsequently, when receiving “password” as a reception message 62a (step 406), the remote console program 40 transmits the password specified by the argument to the electronic apparatus 10 (step 407), thus establishing a connection thereto.

These steps 406 and 407 constitute a process block S102.

Next, the remote console program 40 writes “accept” as a state indication character string 63b to the control file 63, thereby making the state of being able to accept a processing request from the operation program 50 (step 408).

The above step is followed by receiving a message from the electronic apparatus 10 (step 409), validating a connection state and reconnecting if necessary (steps 410 and 422), and displaying the reception message 62a in the terminal window 31 of the display unit 24 (step 411).

In this event, if an output flag 62b for outputting a message to the output file 62 which is specified by the operation program 50 is “ON” (step 412), the remote console program 40 writes the reception message 62a to the output file 62 (step 413).

Then, it reads the control file 63 (step 414), confirms whether or not there is a processing request from the operation program 50 therein (step 415) and, if there is no processing request, returns to the step 409 for repeating a message reception from the electronic apparatus 10 and confirmation of a processing request from the operation program 50.

That is, in the judgment of the step 415, if the “accept” remains as is, as the state indication character string 63b, which is written to the control file 63 by the remote console program 40 in the step 408, then the judgment is that there is no processing request from the operation program 50.

If there is a processing request, it reads the input file 61 (step 416) and judges a processing content from the character string of the control file 63 (step 417).

That is, if “cmd”, as a process request character string 63a, is written to the control file 63 by the operation program 50 in the judgment of the step 417, the remote console program 40 attaches a line feed code to the character string (i.e., a command 61a or data 61b transmitted to the electronic apparatus 10 in this case) which is written to the input file 61 by the operation program 50 (step 418) and transmits it to the electronic apparatus 10 (step 420), followed by returning to the step 408.

If the “ctl”, as a process request character string 63a, is written by the operation program 50 to the control file 63 in the judgment of the step 417, then the remote console program 40 discerns the reserved word 61c written to the input file 61 by the operation program 50 (step 423).

Then, if the reserved word 61c is a control code such as “CTL-A”, “CTL-B”, or the like, “BREAK”, “ESC”, or et cetera, the remote consoleprogram40 converts the character string (i.e., the reserved word 61c) of the input file 61 into a corresponding control code to (step 419) and transmits it to the electronic apparatus 10 (step 420), followed by returning to the step 408.

If the character string (i.e., the reserved word 61c) of the input file 61 is “ON” or “OFF” in the judgment of the step 423, the remote console program 40 sets an output flag 62b for indicating whether or not the reception message 62a is to be output to the output file 62 (step 424) and returns to the step 408.

Incidentally, if the output flag 62b is set to “ON”, it performs open processing for the output file 62, while if the output flag 62b is set to “OFF”, then it performs close processing therefor.

If the character string (i.e., the reserved word 61c) of the input file 61 is “END” in the judgment of the step 423, it cuts the connection to the electronic apparatus 10 (step 425), followed by ending the remote console program 40 (step 426).

Note that transmission processing of a user ID/password is not carried out for the reconnection in the above described step 422. A presentation of prompts (i.e., the reception message 62a), i.e., “login:” and “password:”, from the electronic apparatus 10 to the operation program 50 makes it judge whether or not a connection is made.

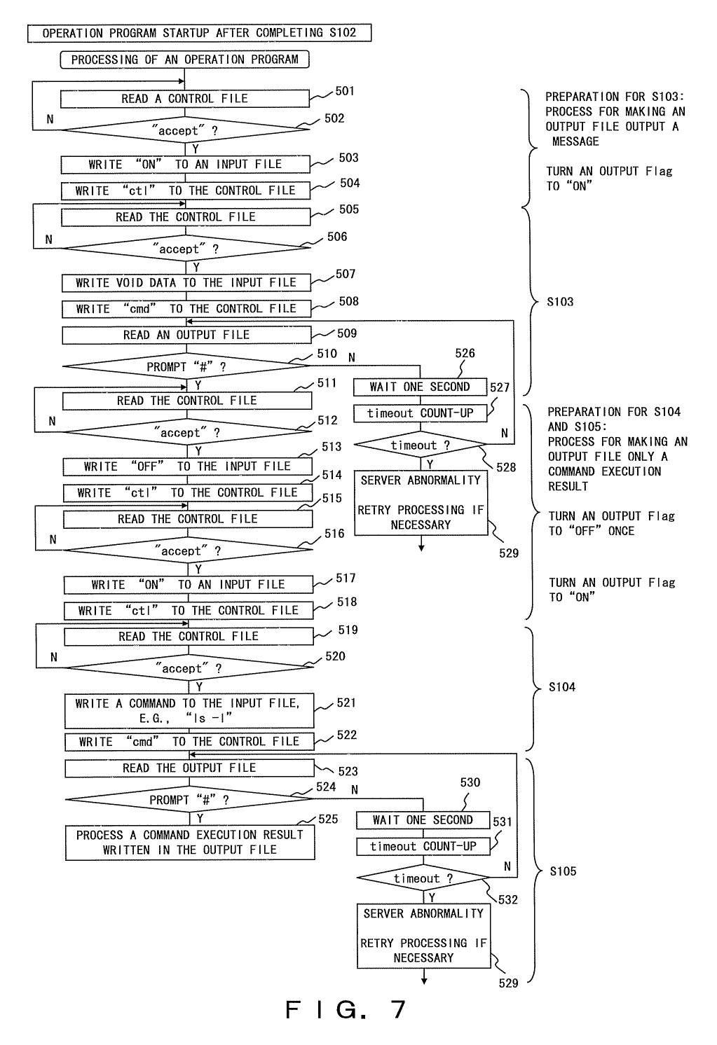

Meanwhile, FIG. 7 is a flow chart exemplifying an operation of an operation program 50, which operates a remote console program 40, for transmitting a command to an electronic apparatus 10 such as a server.

The operation program 50 is started up following a completion of the step 407 in the above described remote console program 40 (i.e., after the completion of certification of the process blocks S101 through 102 by the electronic apparatus 10).

The operation program 50 reads the control file 63 (step 501) and, if “accept” is written (i.e., if in a receivable state) by the remote console program 40 (step 502), writes, to the input file 61, a character string of “ON” as a reserved word 61c for instructing outputting a reception message 62a from the electronic apparatus 10 to the output file 62 (step 503), and then writes “ctl” as a process request character string 63a to the control file 63 (step 504).

The above described steps 501 through 504 are preparation for a later described process block S103.

Incidentally, the “accept” written to the control file 63 by the remote console program 40 is read by the operation program 50 followed by writing “cmd” or “ctl” as a process request character string 63a. This enables the side of the remote console program 40 to know that the operation program 50 has read “accept” from the control file 63, as in the above described step 415 shown in FIG. 6.

And the operation program 50 reads the control file 63 (step 505) and waits for “accept” being written by the side of the remote console program 40 (step 506).

Then, when the remote console program 40 becomes a receivable state, the operation program 50 writes a void data (i.e., “”) to the input file 61 (step 507) and also writes, to the control file 63, “cmd” as a process request character string 63a indicating a command transmission request (step 508).

Then the operation program 50 reads the output file 62, discerns whether or not a prompt of “#” is written by the electronic apparatus 10 (step 510) and judges a command end and an execution result of the command thereat according to the prompt character string.

That is, if there is no response by a prompt of “#” from the electronic apparatus 10 in the judgment of the step 510, it waits a predetermined time only (e.g., one second) (step 526), counts up a timeout counter (step 527) and waits for a prompt from the electronic apparatus 10 by repeating the steps 509, 510, 526 and 527 in the duration of the timeout counter not overflowing (step 528).

If the timeout counter overflows in the step 528, it judges an abnormality occurring at the electronic apparatus 10 and performs a prescribed retry processing on an as required basis (step 529).

The steps 505 through 510 constitute a process block S103 which makes a prompt “#” which is responded from the electronic apparatus 10 to the remote console program 40 written to the output file and the operation program 50 obtains a transmission trigger for the next command transmission.

If there has been a response by a prompt of “#” from the electronic apparatus 10 in the discernment of the step 510, the operation program 50 reads the control file 63 (step 511) and waits until “accept” is written by the remote console program 40 (i.e., the remote console program 40 becomes a receivable state) (step 512).

Then the operation program 50 writes “OFF” to the input file 61 (step 513) and “ctl” to the control file 63 (step 514).

By so doing, the remote console program 40 stops writing the reception message 62a to the output file 62, and only a command execution result (i.e., a prompt of “#” responded to the transmission of a void data in this event) at the electronic apparatus 10 is recorded in the output file 62.

Then the operation program 50 reads the control file 63 (step 515) and waits until “accept” is written by the remote console program 40 (i.e., the remote console program 40 becomes a receivable state) (step 516).

Then the operation program 50 writes “ON” to the input file 61 in order to record a reception message 62a of another processing in the output file 62 (step 517), writes “ctl” to the control file 63 (step 518) and waits for a completion of the processing of setting the output flag 62b to “ON” by the remote console program 40 (steps 519 and 520).

The steps 511 through 518 are preparation for a later described process blocks S104 and S105. In order to make the content of the output file 62 only a command execution result, an output flag 62b is set to “OFF” once for clearing the output file 62.

Then the operation program 50 writes “ls −l” to the input file 61 so as to make the electronic apparatus 10 carry out the command of “ls −l” as another processing (step 521) and writes “cmd” to the control file 63 (step 522).

A process block S104 constituted by the steps 519 through 522 is a process for sending the command of “ls −l” to the electronic apparatus 10.

Note that the “is” command is one for instructing the electronic apparatus 10 to obtain a file list, with the argument of “−l” being an option for instructing an obtainment of detailed information of each file.

Then the operation program 50 reads the output file 62 (step 523) and, if a prompt of “#“is recorded at the end of the reception message 62a (step 524), judges that the electronic apparatus 10 has normally completed a command execution of “ls −l” and accordingly processes the aforementioned command execution result stored by the output file 62 (step 525).

A process block S105 constituted by the steps 523 through 525 earns the output file 62 the command execution result executed in the above described process block S104.

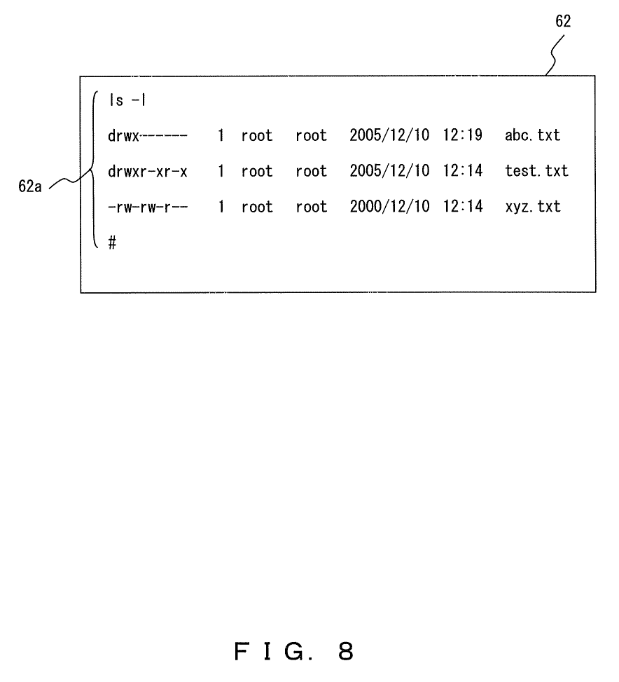

Because the preparatory processing preceding the above described process block S104 has once turned an output of the output file 62 to “OFF”, a prompt of “#” is not output prior to the command of “ls −l” of the output file 62, and therefore it is possible to firmly proceed to the next process by waiting for the next prompt of “#” (i.e., the “#” in the lower most line of the output example shown in FIG. 8).

Note that the fact of repeating, a prescribed number of times (i.e., steps 531 and 532), the process of waiting (i.e., step 530) a prompt of “#” for a predetermined time is the same as the above described steps 526 and 528.

FIG. 8 is a description diagram exemplifying record contents of the output file 62 in the steps 521 through 525.

In this case, the output file 62 is recorded by an echo-back for a command execution instruction of “ls −l” from the electronic apparatus 10, a file list of the execution result (i.e., three files in this case) and the prompt of “#” returned from the electronic apparatus 10 after the command completion, as a reception message 62a.

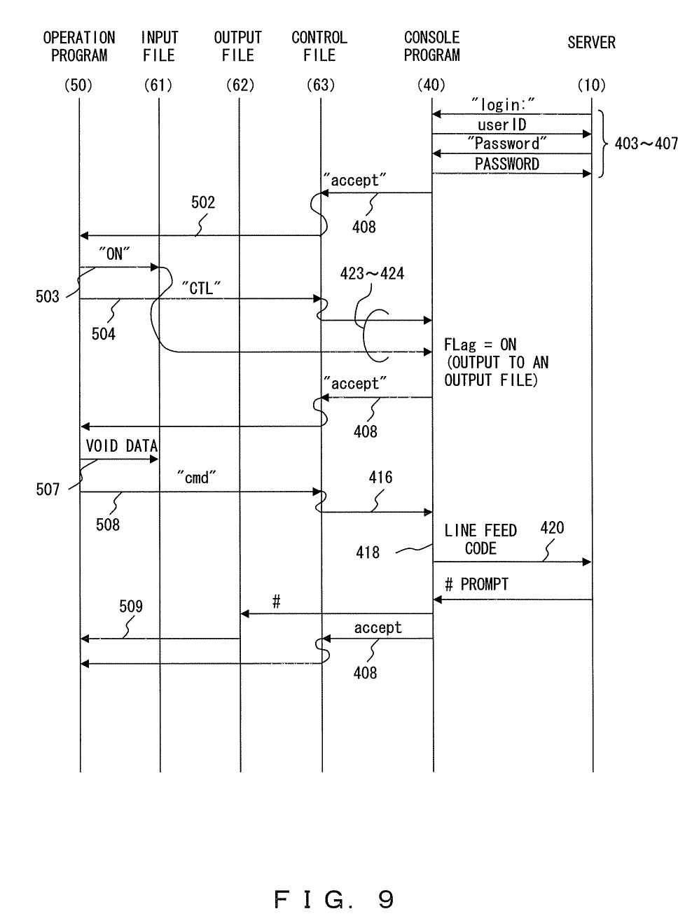

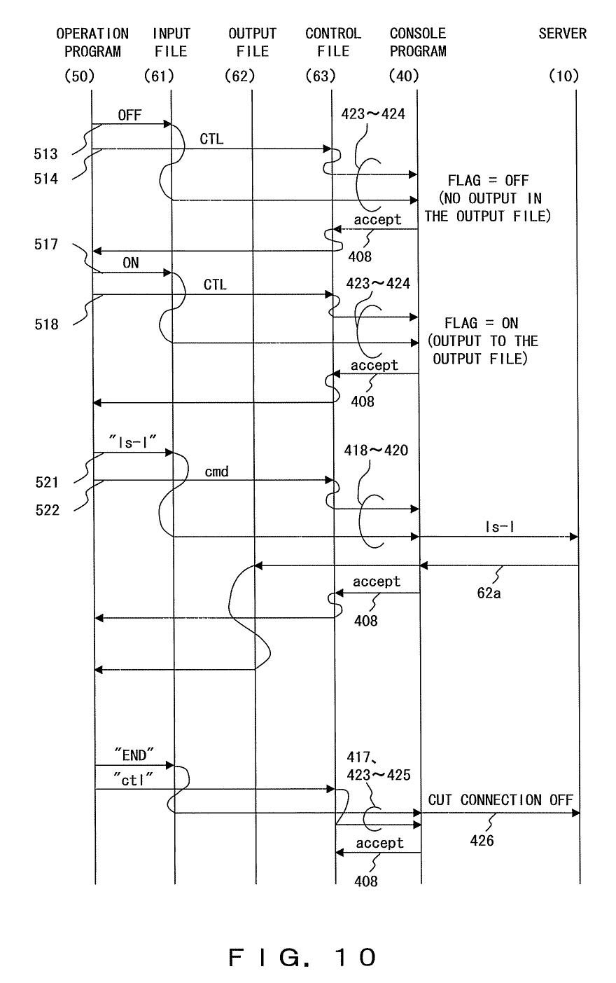

FIGS. 9 and 10 are sequence charts that exemplifies an association of an operation of the remote console program 40 and that of the operation program 50 shown in the above described FIGS. 6 and 7, respectively.

FIGS. 9 and 10 show how the remote console program 40 carries out a remote operation of the electronic apparatus 10, such as a server, by controlling the remote console program 40 as a result of the operation program 50 controlling the input file 61, output file 62 and control file 63.

In the showing of FIGS. 9 and 10, the same step numbers are assigned to the processes corresponding to those of FIGS. 6 and 7 and duplicate descriptions are omitted here.

As described in detail, the present embodiment is configured to use files such as the input file 61, output file 62 and control file 63 which are read from and written to by the operation program 50 as operation interfaces for the remote console program 40, e.g., a telnet client, et cetera.

This makes it possible to judge a content of a console message such as a reception message 62a by way of these files, and send various kinds of commands, data, control codes out to the electronic apparatus 10 such as a server apparatus as the connection destination by way of the remote console program 40 according to the content judged thereby.

This result brings forth the benefit of automating console operations of the remote console program 40 by the operation program 50.

In other words, the case of the remote console apparatus 20 according to the present embodiment makes it possible to implement an automation of key input operations for the user input apparatus 25 of the remote console apparatus 20 without requiring an input unit such as a specially configured key board or touch panel, et cetera, that is, without losing versatility.

It also enables an implementation of automation for operating an electronic apparatus, such as remote operation, remote maintenance, remote monitor, abnormality judgment, automatic recovery and quasi-failure testing, which require complex and diverse key input operations of a remote console without losing versatility.

It is noted that the present invention can apparently be changed in various ways within the scope thereof in lieu of being limited by the configurations exemplified in the above described embodiment.

The present invention enables an implementation of automation of key input operations on a remote console without losing versatility.

It also enables an implementation of automation for operating an electronic apparatus, such as remote operation, remote maintenance, remote monitor, abnormality judgment, automatic recovery, etcetera, which require complex and diverse key input operations of a remote console without losing versatility.

What is claimed is:

1. A remote console apparatus, including:
a storage unit for storing a remote console program which performs a remote operation of an electronic apparatus;
a file for substituting for an operation interface of the remote console program; and
a storage unit for storing an operation program which is connected to the remote console program by way of the file, and automates the remote operation of the electronic apparatus by the remote console program through read and write operations of information from and to the file.

2. The remote console apparatus according to claim 1, wherein
said operation interface includes a key board input and a display indication, and
said file includes an input file corresponding to the key board input, an output file corresponding to the display indication and a control file for synchronizing the remote console program with said operation program.

3. The remote console apparatus according to claim 1, wherein
said operation interface includes a key board input and a display indication,
said file includes an input file corresponding to the key board input, an output file corresponding to the display indication and a control file for synchronizing the remote console program with said operation program;
said operation program comprises the functions of writing, to the input file, a first character string constituted by at least one of a command character string, a data character string and void data which are to be transmitted to said electronic apparatus, and writing, to the control file, a second character string which indicates a transmission request for the first character string; and
the remote console program comprises the function of adding a line feed code for indicating an input break for the key board input to the first character string of the input file, and sending it out to the electronic apparatus, based on the second character string.

4. The remote console apparatus according to claim 1, wherein
said operation interface includes a key board input and a display indication,
said file includes an input file corresponding to the key board input, an output file corresponding to the display indication and a control file for synchronizing the remote console program with said operation program; and
said remote console program comprises the function of recognizing a first character string as a reserved word which indicates a category of a control code generated by the key board input, wherein
the reserved word is written to the input file, and the second character string which indicates a transmission request for the control code is written to the control file, by the operation program, thereby sending out the control code from the remote console program to the electronic apparatus.

5. The remote console apparatus according to claim 1, wherein
said operation interface includes a key board input and a display indication,
said file includes an input file corresponding to the key board input, an output file corresponding to the display indication and a control file for synchronizing the remote console program with said operation program; and
said remote console program comprises the function of recognizing a first character string as a reserved word which indicates an appropriateness of writing processing of a message coming from said electronic apparatus to the output file, wherein
the reserved word is written to the input file, and the second character string which indicates a processing request is written to the control file, by the operation program, thereby controlling an appropriateness of writing the message to the output file.

6. The remote console apparatus according to claim 1, wherein
said operation interface includes a key board input and a display indication,
said file includes an input file corresponding to the key board input, an output file corresponding to the display indication and a control file for synchronizing the remote console program with said operation program; and
said remote console program comprises the function of recognizing a first character string as a reserved word which makes the remote console program ended, wherein
the reserved word is written to the input file, and the second character string which indicates a processing request is written to the control file, by the operation program, thereby disconnecting the remote console program from said electronic apparatus followed by making the remote console program ended.

7. The remote console apparatus according to claim 1, wherein
said remote console program comprises the function of constantly displaying a console message including information exchanging with said electronic apparatus and/or said operation program in an operation screen which has started the aforementioned remote console program.

8. A remote operation method, including:
a first step for connecting, by way of a file which substitutes for an operation interface, a remote console program and an operation program which provide the operation interface for the purpose of performing a remote operation of an electronic apparatus; and
a second step for automatically performing the remote operation of the electronic apparatus by way of the remote console program by the operation program performing read and write operations of information from and to the file.

9. The remote operation method according to claim 8, wherein
said operation interface includes a key board input and a display indication, and
said file includes an input file corresponding to the key board input, an output file corresponding to the display indication and a control file for synchronizing the remote console program with said operation program.

10. The remote operation method according to claim 8, wherein
said operation interface includes a key board input and a display indication,
said file includes an input file corresponding to the key board input, an output file corresponding to the display indication and a control file for synchronizing the remote console program with said operation program; and
said operation program writes, to the input file, a first character string to be transmitted to said electronic apparatus, and writes, to the control file, a second character string for indicating a transmission request for the first character string, while the remote console program adds a line feed code for indicating an input break for the key board input to the first character string, and sends it out to the electronic apparatus, based on the second character string, in said second step.

11. The remote operation method according to claim 8, wherein
said operation interface includes a key board input and a display indication,
said file includes an input file corresponding to the key board input, an output file corresponding to the display indication and a control file for synchronizing said remote console program with said operation program; and
said operation program writes a first character string comprising a reserved word to the input file, and writes, to the control file, a second character string which indicates a processing request for the reserved word, thereby making the remote console program carry out an operation according thereto, in said second step.

12. The remote operation method according to claim 8, wherein
said remote console program restarts an exchange of information with said operation program by way of said file without waiting for a processing complete notification from said electronic apparatus at the time of transmitting the information thereto in said second step.

13. The remote operation method according to claim 8, wherein
said remote console program tries to reconnect to said electronic apparatus at a predetermined interval if a connection between the remote console program and electronic apparatus is cut off, thereby maintaining the connection between the aforementioned two in said second step.

14. A signal for carrying a remote console program, making a computer accomplish the functions of
substituting a file for an operation interface for the purpose of performing a remote operation of an electronic apparatus, and
automatically carrying out the remote operation of the electronic apparatus by using information exchanged with another operation program by way of the file.

15. The signal for carrying a remote console program according to claim 14, wherein
said operation interface includes a key board input and a display indication,
said file includes an input file corresponding to the key board input, an output file corresponding to the display indication and a control file for synchronizing the remote console program with said operation program.

16. The signal for carrying a remote console program according to claim 14, further making a computer accomplish the function of
adding a line feed code to a character string written to said file by said operation program and sending it out to said electronic apparatus.

17. The signal for carrying a remote console program according to claim 14, further making a computer accomplish
the operation according to a reserved word based on a first character string comprising a reserved word written to said file by said operation program and a second character string which indicates a processing request for the reserved word.
